(19) United States
(12) Patent Application Publication
(10) Pub. No.: US 2023/0186356 A1
(43) Pub. Date: Jun. 15, 2023

(54) TRANSACTION PROCESSING SYSTEM AND PAYMENT APPARATUS

(71) Applicant: TOSHIBA TEC KABUSHIKI KAISHA, Tokyo (JP)

(72) Inventor: Naoki KURIHARA, Mishima Shizuoka (JP)

(21) Appl. No.: 17/884,937

(22) Filed: Aug. 10, 2022

(30) Foreign Application Priority Data
Dec. 15, 2021 (JP) 2021-203466

(51) Int. Cl. G06Q 30/06; G06Q 20/38

(52) U.S. Cl. CPC G06Q 30/06; G06Q 20/389

(57) ABSTRACT

According to an embodiment, a transaction processing system includes: a transaction processing apparatus, a payment apparatus, and a management apparatus. The transaction processing apparatus transmits first data indicating a result of adjustment for a plurality of processed transactions to the payment apparatus. The payment apparatus converts the first data into second data and transmits the second data to the management apparatus. The management apparatus manages the second data.

### CROSS-REFERENCE TO RELATED APPLICATIONS

This application is based upon and claims the benefit of priority from the prior Japanese Patent Application No. 2021-203466, filed on Dec. 15, 2021, the entire contents of which are incorporated herein by reference.

### FIELD

An embodiment to be described here generally relates to a transaction processing system and a payment apparatus.

### BACKGROUND

In a shopping center where a plurality of tenants open, when payment is made using some payment methods such a credit card and electronic money, a payment apparatus provided from the operator of the shopping center to the tenant is used in some cases. However, even in this case, as a transaction processing apparatus such as a POS terminal for processing a transaction, the one independently selected by the tenant is used in some cases. The payment apparatus and the transaction processing apparatus are not linked. Meanwhile, in such a shopping center, the operator of the shopping center often manages the transaction performance of each tenant. For this reason, in the adjustment work relating to a plurality of transactions performed within a predetermined adjustment period, e.g., daily, a transaction processing apparatus issues an adjustment sheet obtained by printing, on receipt paper, the result of adjustment relating to a plurality of processed transactions of the transaction processing apparatus within the corresponding adjustment period. This adjustment sheet is submitted by the tenant to the operator. Thus, it has been troublesome for both the tenant and the operator to manage the transaction performance of the tenant by the operator. Under such circumstances, it has been desired to make the management of the transaction performance of the tenant by the operator more easily.

### BRIEF DESCRIPTION OF THE DRAWINGS

FIG. 1 is a block diagram showing a transaction processing system according to an embodiment;

FIG. 2 is a block diagram showing an example of a main circuit of a transaction processing apparatus according to the embodiment;

FIG. 3 is a block diagram showing a main circuit of a payment apparatus according to the embodiment;

FIG. 4 is a block diagram showing a main circuit of a management server according to the embodiment;

FIG. 5 a diagram schematically showing one structure of a data record included in a management database according to the embodiment;

FIG. 6 is a flowchart showing adjustment processing performed by a processor of the transaction processing apparatus according to the embodiment;

FIG. 7 is a flowchart showing scraping processing performed by the processor of the transaction processing apparatus according to the embodiment;

FIG. 8 is a flowchart showing adjustment processing performed by a processor of a payment apparatus according to the embodiment;

FIG. 9 is a flowchart showing upload processing performed by the processor of the payment apparatus according to the embodiment; and

FIG. 10 is a flowchart showing collection processing performed by a processor of the management server according to the embodiment.

### DETAILED DESCRIPTION

According to an embodiment, a transaction processing system includes: a plurality of transaction processing apparatuses, each of which executes information processing for processing a transaction; a plurality of payment apparatuses, each of which is connected to the corresponding transaction processing apparatus and executes information processing for payment relating to the transaction processed by the information processing executed by the transaction processing apparatus; and a management apparatus that manages the transaction processed by the information processing executed by the transaction processing apparatus. Each of the transaction processing apparatuses includes a first communication device and a first processor. The first communication device performs data communication with the corresponding payment apparatus. The first processor is configured to generate first data indicating a result of adjustment for a plurality of processed transactions. The first processor is further configured to transmit the generated first data to the payment apparatus via the first communication device. Each of the payment apparatuses includes a second communication device and a second processor. The second communication device performs data communication with the corresponding transaction processing apparatus and the management apparatus. The second processor is configured to receive, via the second communication device, the first data transmitted via the first communication device. The second processor is further configured to convert the first data received via the second communication device into second data. The second processor is further configured to transmit the second data obtained by the conversion to the management apparatus via the second communication device. The management apparatus includes a third communication device and a third processor. The third communication device performs data communication with the payment apparatus. The third processor is configured to receive, via the third communication device, the second data transmitted via the second communication device. The third processor is further configured to manage the second data received via the third communication device.

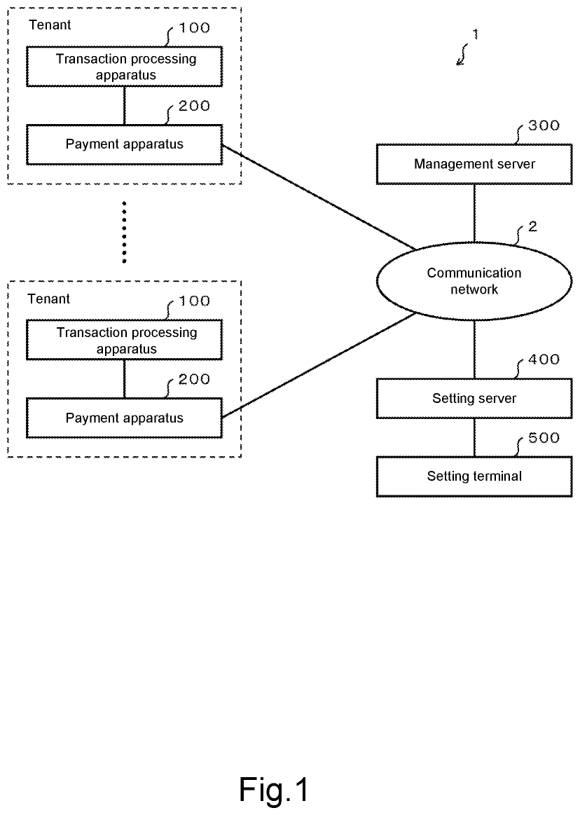

An example of an embodiment will be described below with reference to the drawings. In the drawings, the same reference symbols indicate the same or similar portions. Note that in this embodiment, a transaction processing system that processes a transaction performed by each of a plurality of tenants opening in a shopping center will be described as an example. FIG. 1 is a block diagram showing a transaction processing system 1 according to this embodiment. The transaction processing system 1 includes a plurality of transaction processing apparatuses 100, a plurality of payment apparatuses 200, a management server 300, a setting server 400, and a setting terminal 500.

Each of the plurality of transaction processing apparatuses 100 is an information processing apparatus that executes information processing such as registration of a transaction such as product sales and calculation of a payment amount relating to the registered transaction. As the transaction processing apparatus 100, for example, an existing POS terminal apparatus or an existing cash register may be used. The plurality of transaction processing apparatuses 100 is used in a respective plurality of tenants. The plurality of transaction processing apparatuses 100 does not need to have the same configuration. However, the plurality of transaction processing apparatuses 100 may include transaction processing apparatuses 100 having the same configuration. For example, the transaction processing apparatus 100 is appropriately selected by an individual tenant.

The payment apparatus 200 is, for example, an information processing apparatus that executes information processing for payment processing using a payment service provided as a cloud service via a communication network 2. The payment apparatus 200 generates adjustment data (hereinafter, referred to as the transaction adjustment data) representing the result of adjustment of the performance relating to the transaction processed by the transaction processing apparatus 100 that is the connection destination. The payment apparatus 200 transmits the generated transaction adjustment data to the management server 300. The plurality of payment apparatuses 200 has basically the same configuration. For example, the payment apparatus 200 is lent to a tenant from the operator. The payment apparatus 200 is communicably connected to the transaction processing apparatus 100 used by the same tenant. The connection form between the transaction processing apparatus 100 and the payment apparatus 200 may be arbitrary. For example, the connection form may be a wired connection using an interface standard such as RS-232C and USB (universal serial bus) or a wireless connection using a wireless communication standard such as a wireless LAN (local area network) and Bluetooth (registered trademark). Note that a plurality of sets of the transaction processing apparatus 100 and the payment apparatus 200 connected to each other may be used in one tenant.

The management server 300 is capable of communicating with the respective plurality of payment apparatuses 200 via the communication network 2. The management server 300 is an information processing apparatus that performs information processing for managing the performance of a transaction in each tenant and the performance of payment using a payment service. That is, the management server 300 corresponds to a management apparatus that manages the transaction processed by the transaction processing apparatus 100.

The setting server 400 is capable of communicating with the respective plurality of payment apparatuses 200 via the communication network 2. The setting server 400 stores, for each of the plurality of payment apparatuses 200, a setting file representing settings such as a condition for generating the transaction adjustment data in the payment apparatus 200. The setting server 400 provides the stored setting file to the payment apparatus 200.

The setting terminal 500 is a user interface terminal that receives an operation for changing the settings represented by the setting file. As the communication network 2, typically, a LAN is used. However, as the communication network 2, in addition to the LAN, the Internet, a VPN, a public communication network, a mobile communication network, and the like may be used alone or in combination with each other as appropriate.

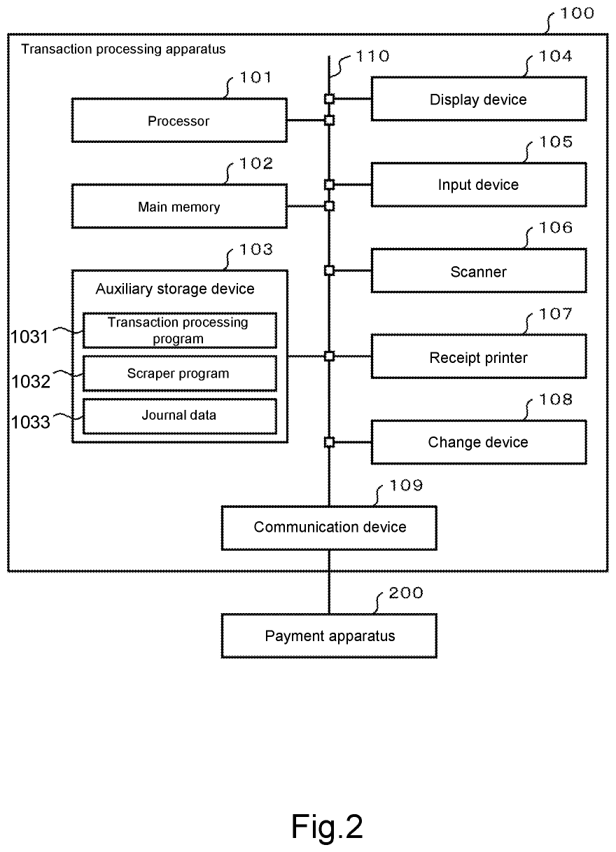

FIG. 2 is a block diagram showing an example of a main circuit of the transaction processing apparatus 100. The transaction processing apparatus 100 includes a processor 101, a main memory 102, an auxiliary storage device 103, a display device 104, an input device 105, a scanner 106, a receipt printer 107, a change device 108, a communication device 109, and a transmission path 110.

The processor 101, the main memory 102, and the auxiliary storage device 103 are connected to each other via the transmission path 110 to configure a computer for executing information processing relating to control of the transaction processing apparatus 100. The processor 101 corresponds to the brain of the computer. The processor 101 executes an information processing program such as an operating system, middleware, and an application program stored in the main memory 102 and the auxiliary storage device 103 to control the respective units of the transaction processing apparatus 100 in order to realize various functions of the transaction processing apparatus 100.

The main memory 102 corresponds to the main storage portion of the computer. The main memory 102 includes a non-volatile memory area and a volatile memory area. The main memory 102 stores the information processing program in the non-volatile memory area. Further, the main memory 102 stores, in the non-volatile or volatile memory area, data necessary for the processor 101 to execute various types of information processing in some cases. The volatile memory area of the main memory 102 is used as a work area where data is appropriately rewritten by the processor 101.

The auxiliary storage device 103 corresponds to the auxiliary storage portion of the computer. The auxiliary storage device 103 includes a well-known storage device such as an EEPROM (electric erasable programmable read-only memory), an HDD (hard disc drive), and an SSD (solid state drive). The auxiliary storage device 103 stores data used by the processor 101 for performing various types of information processing and data generated by the processing of the processor 101. The auxiliary storage device 103 stores the information processing program in some cases. In this embodiment, the auxiliary storage device 103 stores a transaction processing program 1031 and a scraper program 1032. The transaction processing program 1031 is an information processing program that describes a procedure of information processing for transaction processing. The scraper program 1032 is an information processing program that describes a procedure of information processing (hereinafter, referred to as the scraping processing) described below. Further, in this embodiment, the auxiliary storage device 103 stores journal data 103. The journal data 1033 is data representing a history relating to a processed transaction. The transaction processing program 1031 may differ between the plurality of transaction processing apparatuses 100. The scraper program 1032 is common to the plurality of transaction processing apparatuses 100. The content of the journal data 1033 may differ between the plurality of transaction processing apparatuses 100.

The display device 104 includes one or more well-known display devices such as a liquid crystal display device. The display device 104 displays a screen for presenting information to an operator such as a sales clerk. Note that the display device 104 may include a display device provided on a touch panel.

The input device 105 inputs an instruction of an operator in accordance with an operation by the operator. The input device 105 includes, individually or in combination with each other, various operation devices such as a touch sensor, a keyboard, and various switches provided in a touch panel.

The scanner 106 reads a barcode and a two-dimensional code to recognize data represented by the barcode and the two-dimensional code. The scanner 106 recognizes the data represented by the barcode and the two-dimensional code by, for example, performing image processing on the data obtained by imaging a product held in front of a reading window by a camera. Alternatively, the scanner 106 uses reflection of a laser beam to optically read the barcode or the two-dimensional code. Note that the scanner 106 may specify a product using an object recognition technology on the basis of an image of the product itself obtained by imaging the product. The receipt printer 107 prints various images on receipt paper to issue various certificates such as a receipt, a sales slip, and an adjustment sheet.

The change device 108 houses coins inserted from a coin insertion slot in an internal storage while calculating the amount of money. The change device 108 ejects the coins housed in the storage to a coin tray via a coin ejection slot. The change device 108 houses bills inserted from a bill insertion slot in an internal storage while calculating the amount of money. The change device 108 ejects the bills housed in the storage from a bill ejection slot.

The communication device 109 performs communication processing for transmitting/receiving various types of data to/from the payment apparatus 200. As the communication device 109, an existing communication device conforming to the interface standard used for communication with the payment apparatus 200 can be used. The transmission path 110 includes an address bus, a data bus, a control signal line, and the like. The transmission path 110 transmits data and signals transmitted and received between the connected units.

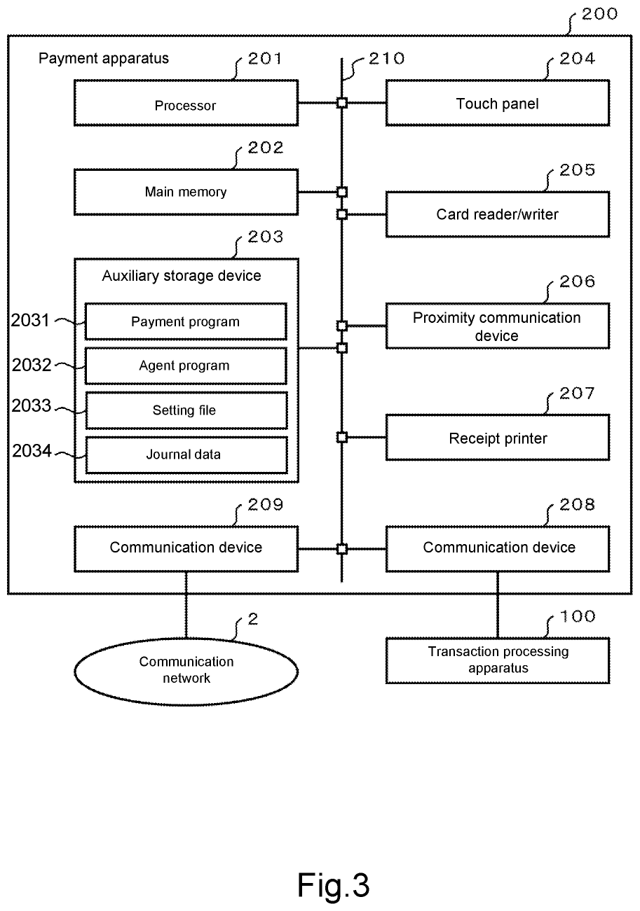

FIG. 3 is a block diagram showing a main circuit of the payment apparatus 200. The payment apparatus 200 includes a processor 201, a main memory 202, an auxiliary storage device 203, a touch panel 204, a card reader/writer 205, a proximity communication device 206, a receipt printer 207, communication devices 208 and 209, and a transmission path 210.

The processor 201, the main memory 202, and the auxiliary storage device 203 are connected to each other via the transmission path 210 to configure a computer for executing information processing relating to control of the transaction processing apparatus 100.

The processor 201 corresponds to the brain of the computer. The processor 201 executes an information processing program such as an operating system, middleware, and an application program stored in the main memory 202 and the auxiliary storage device 203 to control the respective units of the payment apparatus 200 in order to realize various functions of the payment apparatus 200.

The main memory 202 corresponds to the main storage portion of the computer. The main memory 202 includes a non-volatile memory area and a volatile memory area. The main memory 202 stores the information processing program in the non-volatile memory area. Further, the main memory 202 stores, in the non-volatile or volatile memory area, data necessary for the processor 201 to execute various types of information processing in some cases. The volatile memory area of the main memory 202 is used as a work area where data is appropriately rewritten by the processor 201.

The auxiliary storage device 203 corresponds to the auxiliary storage portion of the computer. The auxiliary storage device 203 includes a well-known storage device such as an EEPROM, an HDD, and an SSD. The auxiliary storage device 203 stores data used by the processor 201 for performing various types of information processing and data generated by the processing of the processor 201. The auxiliary storage device 203 stores the information processing program in some cases. In this embodiment, the auxiliary storage device 203 stores a payment program 2031 and an agent program 2032. The payment program 2031 is an information processing program that describes a procedure of information processing for payment. The agent program 2032 is an information processing program that describes a procedure of information processing described below (hereinafter, referred to as the extraction processing). Further, in this embodiment, the auxiliary storage device 203 stores a setting file 2033 and journal data 2034. The setting file 2033 is a file downloaded from the setting server 400. The journal data 2034 is data representing a history relating to processed payment.

The touch panel 204 displays a screen for presenting information to an operator such as a sales clerk. The touch panel 204 inputs an instruction of an operator in accordance with an operation by the operator. The card reader/writer 205 reads card data recorded on a predetermined card such as a credit card, a membership card, and a prepaid card. Further, the card reader/writer 205 writes arbitrary data to the predetermined card such as a membership card.

The proximity communication device 206 performs proximity wireless communication with a nearby wireless tag to acquire data stored in the wireless tag. Further, the proximity communication device 206 writes arbitrary information to the wireless tag by the proximity wireless communication. The receipt printer 207 prints various images on receipt paper to issue various certificates such as a receipt, a sales slip, and an adjustment sheet.

The communication device 208 performs communication processing for transmitting/receiving various types of data to/from the transaction processing apparatus 100. As the communication device 208, an existing communication device conforming to the interface standard used for communication with the transaction processing apparatus 100 can be used. The communication device 209 performs communication processing for data communication via the communication network 2. As the communication device 209, an existing communication device adapted to the communication method of the communication network 2 can be used. The transmission path 210 includes an address bus, a data bus, a control signal line, and the like. The transmission path 210 transmits data and signals transmitted and received between the connected units.

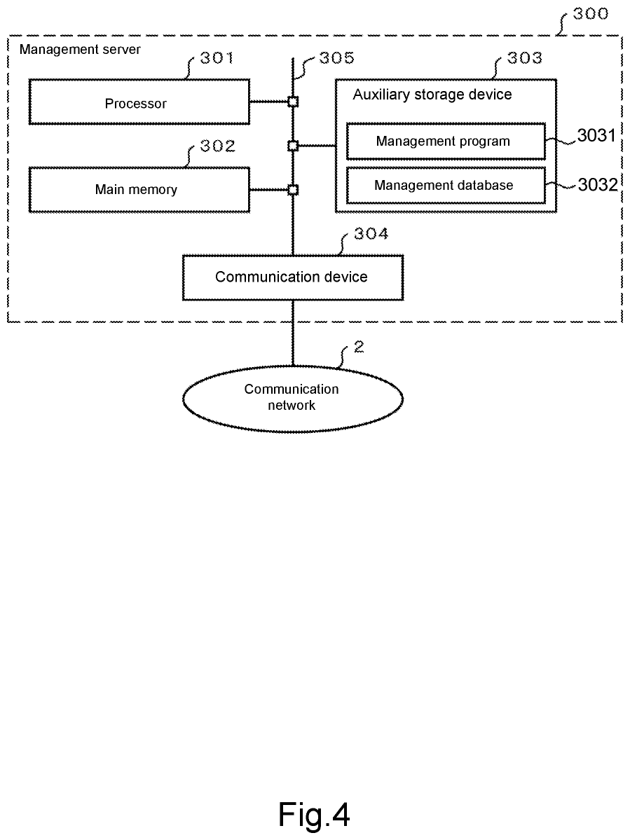

FIG. 4 is a block diagram showing a main circuit of the management server 300. The management server 300 includes a processor 301, a main memory 302, an auxiliary storage device 303, a communication device 304, and a transmission path 305. As the hardware of the management server 300, for example, a general-purpose server apparatus can be used.

The processor 301, the main memory 302, and the auxiliary storage device 303 are connected to each other via the transmission path 305 to configure a computer for managing the transaction processed by the transaction processing system 1 and payment of the transaction. The processor 301 corresponds to the brain of the computer. The processor 301 executes an information processing program such as an operating system, middleware, and an application program stored in the main memory 302 and the auxiliary storage device 303 to execute information processing the management.

The main memory 302 corresponds to the main storage portion of the computer. The main memory 302 includes a non-volatile memory area and a volatile memory area. The main memory 302 stores the information processing program in the non-volatile memory area. Further, the main memory 302 stores, in the non-volatile or volatile memory area, data necessary for the processor 301 to execute various types of information processing in some cases. The volatile memory area of the main memory 302 is used as a work area where data is appropriately rewritten by the processor 301.

The auxiliary storage device 303 corresponds to the auxiliary storage portion of the computer. The auxiliary storage device 303 includes a well-known storage device such as an EEPROM, an HDD, and an SSD. The auxiliary storage device 303 stores data used by the processor 301 for performing various types of information processing and data generated by the processing of the processor 301. The auxiliary storage device 303 stores the information processing program in some cases. In this embodiment, the auxiliary storage device 303 stores a management program 3031 that is one of the information processing programs. The management program 3031 is an application program that describes a procedure of information processing (hereinafter, referred to as the management processing) for managing the transaction processed by the transaction processing system 1 and payment of the transaction. Part of the storage area of the auxiliary storage device 303 is used as a management database 3032.

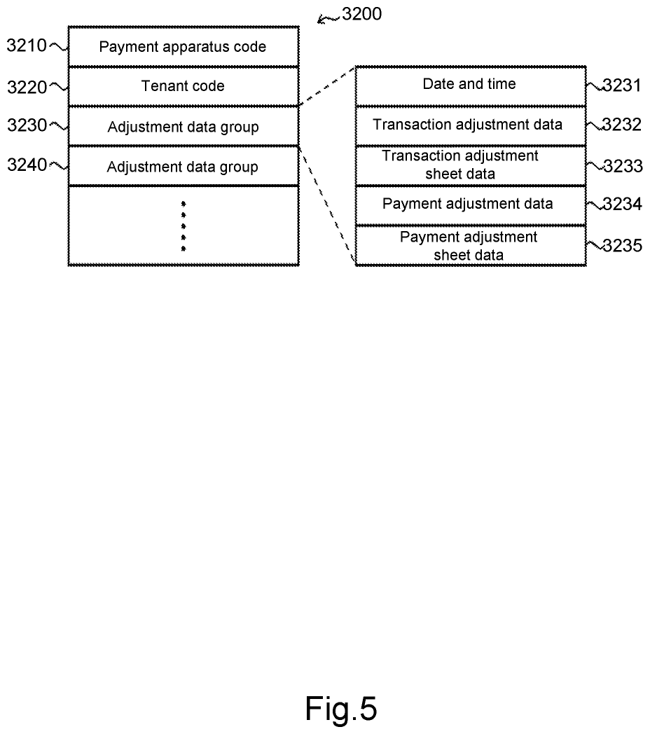

FIG. 5 is a diagram schematically showing one structure of a data record 3200 included in the management database 3032. The data record 3200 is associated with each of the plurality of payment apparatuses 200. That is, the management database 3032 is a collection of a plurality of data records 3200. The data record 3200 includes fields 3210, 3220, 3230 . . . . A payment apparatus code as an identifier of the associated payment apparatus 200 is set in the field 3210. A tenant code as an identifier of a tenant that uses the associated payment apparatus 200 is set in the field 3220. An adjustment data group relating to a transaction processed by the transaction processing apparatus 100 to which the associated payment apparatus 200 is connected and payment processed by the associated payment apparatus 200 is set in each of the field 3230 and subsequent fields.

The field 3230 of an adjustment data group includes fields 3231, 3232, 3233, 3234, and 3235. The date and time relating to the corresponding adjustment data group is set in the field 3231. Transaction adjustment data, transaction adjustment sheet data, payment adjustment data, and payment adjustment sheet data are respectively set in the fields 3232 to 3235. The transaction adjustment data, the transaction adjustment sheet data, the payment adjustment data, and the payment adjustment sheet data will be described below. Note that the management database 3032 is written to the auxiliary storage device 103 when, for example, the transaction processing system 1 is constructed. However, in each data record 3200 of the initial management database 3032, only a payment apparatus code and a tenant code are set in the fields 3210 and 3220 and no adjustment data group is set in the field 3230 and subsequent fields.

The communication device 304 performs processing for data communication via the communication network 2. As the communication device 304, an existing communication device adapted to the communication method of the communication network 2 can be used. The transmission path 305 includes an address bus, a data bus, a control signal line, and the like. The transmission path 305 transmits data and signals transmitted and received between the connected units.

Incidentally, the transaction processing program 1031, the scraper program 1032, the payment program 2031, the agent program 2032, and the management program 3031 may be stored in the auxiliary storage devices 103, 203, and 303 when the transaction processing apparatus 100, the payment apparatus 200, and the management server 300 are transferred. The respective programs transferred separately from the hardware of the transaction processing apparatus 100, the payment apparatus 200, and the management server 300 may be written to the auxiliary storage devices 103, 203, and 303 by the processors 101, 201, and 301 in accordance with an operation of an arbitrary worker. Note that when transferring the respective programs separately from the hardware, the programs may be recorded on a removable recoding medium such as a magnetic disc, a magneto-optical disc, an optical disc, and a semiconductor memory and transferred, or may be transferred by communication via a network.

Next, an operation of the transaction processing system 1 configured as described above will be described. Note that the content of various types of processing described below is merely an example, and it is possible to change the order of part of the processing, omit part of the processing, or add other processing as appropriate.

In the case of a transaction in a tenant, the transaction processing apparatus 100 used in the tenant registers the content of the transaction and calculates the payment amount corresponding to the registered transaction content. In the case where a payment service that should use the payment apparatus 200 is not used, for example, cash payment using the change device 108 is performed without using the payment apparatus 200. In the case where a payment service that should use the payment apparatus 200 is used, information necessary for payment is input to the payment apparatus 200 by an operation by an operator of the touch panel 204. Then, payment using a payment service is executed by the payment apparatus 200. Note that the operation of the transaction processing apparatus 100 in this case may be similar to the operation of an existing POS terminal or an existing cash register, for example. Further, the operation of the payment apparatus 200 may be similar to the operation of an existing payment apparatus, for example. That is, in the transaction processing apparatus 100, the processor 101 executes transaction processing similar to that executed by a processor of an existing POS terminal or an existing cash register, in accordance with a transaction processing program PRA. Further, in the payment apparatus 200, the processor 201 executes payment processing similar to that executed by a processor of an existing payment apparatus, in accordance with the payment program 2031.

Note that the transaction processing apparatus 100 adds various types of information relating to the executed transaction processing to the journal data 1033. Further, the payment apparatus 200 adds various types of information relating to the executed payment to the journal data 2034. The pieces of journal data 1033 and 2034 may include the content of a transaction such as a list of products to be traded, the content of payment such as a payment method and a payment amount, as well as ancillary information such as an operation log.

Incidentally, when predetermined adjustment timing has been reached, a worker such as a tenant sales clerk instructs the transaction processing apparatus 100 and the payment apparatus 200 to execute adjustment in accordance with, for example, a predetermined operation by the input device 105 and the touch panel 204, respectively. The adjustment timing is typically the daily adjustment timing after the tenant's business is closed. However, the adjustment timing may be, for example, timing for each predetermined time set as once or a plurality of times in a day or timing for each period including a plurality of business days such as one week and one month.

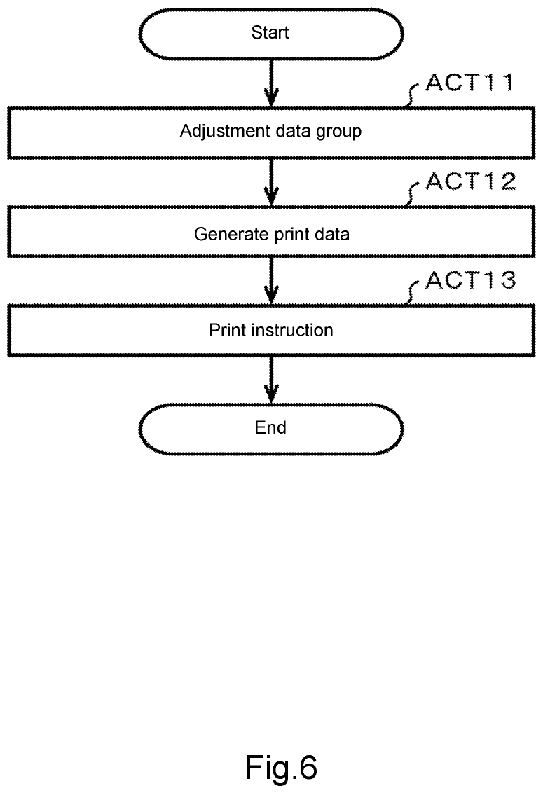

In the transaction processing apparatus 100, when adjustment execution is instructed, the processor 101 executes adjustment processing in accordance with the transaction processing program 1031. FIG. 6 is a flowchart showing adjustment processing by the processor 101.

In ACT11, the processor 101 executes adjustment processing of transaction performance. The processor 101 adjusts, regarding a plurality of predetermined items, information relating to a transaction processed in a predetermined adjustment period, which is included in the journal data 1033, for example. Assumption is made that the adjustment period is, for example, within the latest one business period. Examples of the assumed item of an adjustment target include the number of customers, the total cash sales, the total sales, and the total tax. Note that what kind of period the adjustment period should be and what kind of item is to be adjusted may differ for each of the plurality of transaction processing apparatuses 100 depending on the circumstances of each tenant, the settings of the transaction processing apparatus 100, or the like.

In ACT12, the processor 101 generates print data of an adjustment sheet representing the adjustment result in ACT11. This print data is data representing an image in which a character string representing each item to be adjusted and a character string representing a numerical value obtained by the adjustment result or the like are two-dimensionally disposed in a predetermined form. For example, the print data is text format data including a series of a character code representing a character represented in the image and a character code representing a control character for controlling the arrangement of the character in the image. In ACT13, the processor 101 instructs the receipt printer 107 to print an adjustment sheet based on the print data generated as described above (print instruction). Thus, the processor 101 ends the adjustment processing.

The receipt printer 107 issues an adjustment sheet obtained by printing the image represented by the print data on receipt paper in accordance with the print instruction in ACT13 described above. Note that when this print instruction is made, the print data is delivered to a printer driver. Then, the processor 101 controls the receipt printer 107 by the function of the printer driver.

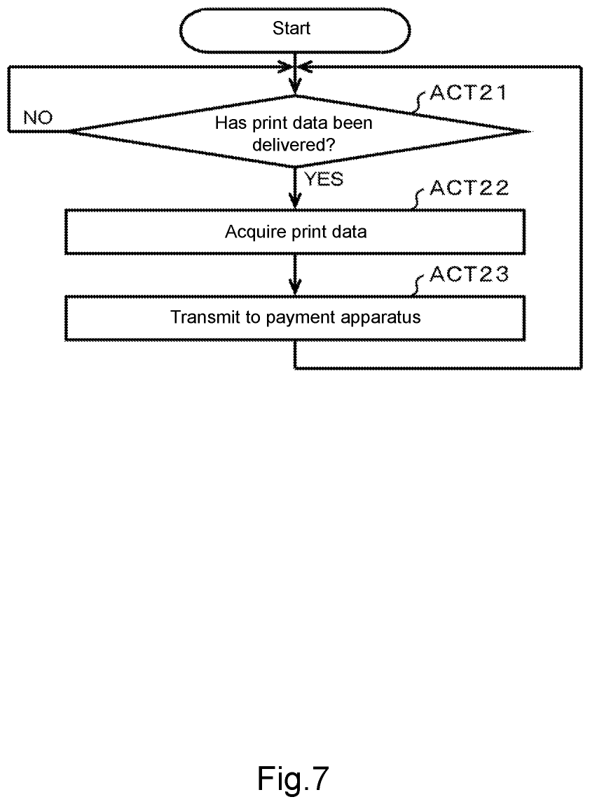

Meanwhile, the processor 101 executes scraping processing as processing of a thread different from that of adjustment processing in accordance with the scraper program 1032. FIG. 7 is a flowchart showing scraping processing by the processor 101.

In ACT21, the processor 101 determines whether or not print data has been delivered to the printer driver. In the case where it is determined that print data has not been delivered to the printer driver (NO in ACT21), the processor 101 stands by until print data is delivered. In the case where it is determined that print data has been delivered to the printer driver (YES in ACT21) by, for example, the adjustment processing as described above, the processing of the processor 101 proceeds to ACT22.

In ACT22, the processor 101 acquires print data to be delivered to the printer driver. Note that in many existing POS terminals or existing cash registers, print data relating to receipt printing is transmitted and received in accordance with OPOS (open POS) specifications. For this reason, the processor 101 is capable of acquiring print data in scraper processing in accordance with the OPOS specifications, for example. In ACT23, the processor 101 transmits the print data acquired as described above to the payment apparatus 200 from the communication device 109. After that, the processing of the processor 101 returns to the stand-by state in ACT21.

The print data to be transmitted by scraping processing as described above is an example of first data that is data relating to an image representing a result of adjustment for a plurality of processed transactions. When the processor 101 executes information processing based on the scraper program 1032, a computer that includes the processor 101 as the brain realizes the function as a first transmission means that transmits print data as first data, in cooperation with the communication device 109.

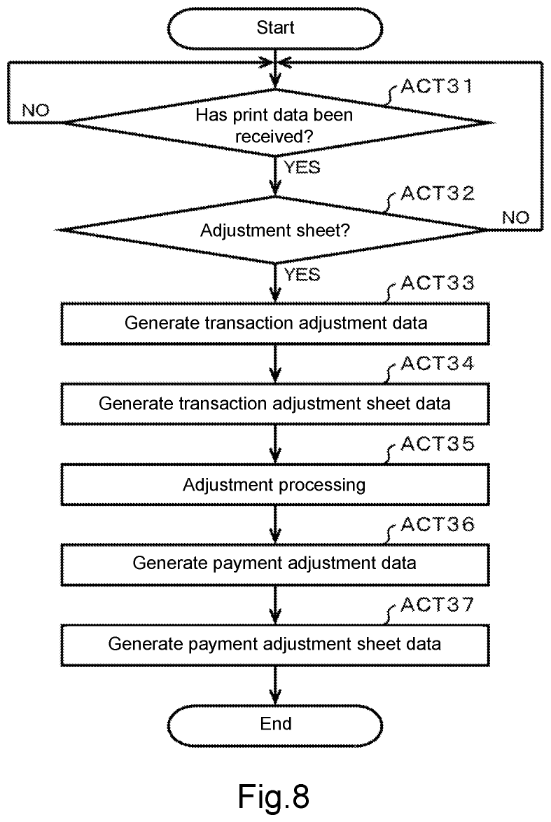

In the payment apparatus 200, when adjustment execution is instructed, the processor 201 executes adjustment processing in accordance with a payment program PRC. FIG. 8 is a flowchart showing adjustment processing performed by the processor 201.

In ACT31, the processor 201 determines whether or not the print data transmitted from the transaction processing apparatus 100 as described above has been received by the communication device 209. In the case where it is determined that the print data has not been received (NO in ACT31), the processing of the processor 201 returns to the stand-by state standing by for the print data to be received. The communication device 209 is an example of a first reception means. In the case where it is determined that the print data has been received by the communication device 209 (YES in ACT31), the processing of the processor 201 proceeds to ACT32.

In ACT32, the processor 201 checks whether or not the received print data is print data relating to an adjustment sheet. The processor 201 performs the checking on the basis of whether or not a predetermined keyword such as “adjustment” is included in a predetermined position of the image represented by the print data. More specifically, the processor 201 checks whether or not a character code string forming the print data includes continuous character codes representing “adjustment” included as a character that should be represented in a predetermined position in the image. In the case where it is confirmed that the received print data is not print data relating to an adjustment sheet (NO in ACT32), the processing of the processor 201 returns to the stand-by state in ACT31.

Note that the form of the print data differs for each of the transaction processing apparatuses 100 in some cases, and the character string that can be used as a keyword and the arrangement position of the character string vary. In this regard, the processor 201 determines, on the basis of the settings represented in the setting file 2033, a character string used as a keyword and a position where the character string should be searched for. The setting file 2033 is prepared in advance for each of the payment apparatuses 200 to include setting data representing a character string used as a keyword and a position where the character string should be searched for in consideration of the form of the print data generated in the transaction processing apparatus 100 connected to the corresponding payment apparatus 200.

In the case where it is confirmed that the received print data is print data relating to an adjustment sheet (YES in ACT32), the processing of the processor 201 proceeds to ACT33. In ACT33, the processor 201 generates the transaction adjustment data on the basis of the received print data. The processor 201 starts, as processing of another thread, the extraction processing according to the agent program 2032, for example. In the extraction processing, the processor 201 extracts, as a character string that should be represented in an image of an adjustment sheet, a character string representing an item name and a numerical value relating to a predetermined item from character strings included in the print data. The processor 201 determines the value of each of the items from the extracted character string. For example, the processor 201 extracts character strings of “the number of customers 12”, “cash sales 10000”, “total sales 33000”, and “total tax 3000” from the print data and determines “the number of customers”, “cash sales”, “total sales”, “total tax”, “12”, “10000”, “33000”, and “3000” as the values of the items.

Note that the form of the print data differs for each of the transaction processing apparatuses 100 in some cases and also the item to be extracted differs in some cases. In this regard, the processor 201 determines the item to be extracted on the basis of the setting represented by the setting file 2033. The setting file 2033 is prepared in advance for each of the payment apparatuses 200 to include setting data representing an item to be extracted in consideration of the form of the print data generated in the transaction processing apparatus 100 connected to the corresponding payment apparatus 200.

Then, in ACT33, the processor 201 generates transaction adjustment data as data representing the numerical values extracted by the extraction processing in a form that can be interpreted by a computer. Note that the form representing the respective values in the transaction adjustment data may be arbitrary. As an example, the respective values only need to be represented in a form of “<number of customers>12</number of customers>”. The transaction adjustment data corresponds to the second data. Thus, generation of the transaction adjustment data corresponds to converting print data as first data into transaction adjustment data as second data. That is, when the processor 201 executes information processing based on the payment program 2031, a computer that includes the processor 201 as the brain functions as a conversion means.

In ACT34, the processor 201 generates transaction adjustment sheet data. The transaction adjustment sheet data is data representing an image of a transaction adjustment sheet. The processor 201 generates transaction adjustment sheet data as data of an image represented by disposing character strings representing item names and numerical values such that humans can easily grasp which item each of the values extracted by the extraction processing relates to. Also the transaction adjustment sheet data is, for example, text format data similar to print data of an adjustment sheet. The processor 201 generates transaction adjustment sheet data in a predetermined form regardless of the form of an adjustment sheet represented by the print data received from the transaction processing apparatus 100. The transaction adjustment sheet data corresponds to third data. Thus, when the processor 201 executes information processing based on the payment program 2031, a computer that includes the processor 201 as the brain functions as a first generation means.

In ACT35, the processor 201 executes adjustment processing of payment performance. The processor 201 adjusts, regarding a plurality of predetermined items, information relating to payment processed in a predetermined adjustment period, which is included in the journal data 2034, for example. Assumption is made that the adjustment period is, for example, within the latest one business period. Examples of the assumed item of an adjustment target include a credit payment amount, an electronic money payment amount, a gift certificate payment amount, and a total payment amount. Note that what kind of period the adjustment period should be and what kind of item is to be adjusted may be appropriately determined by an operator or the like.

In ACT36, the processor 201 generates payment adjustment data as data representing the numerical values obtained as a result of the adjustment in ACT35 in a form that can be interpreted by a computer. Note that the form representing the respective values in the payment adjustment data may be arbitrary. As an example, the respective values only need to be represented in a form of “<credit payment amount>3000</credit payment amount>” similar to the transaction adjustment data. The payment adjustment data corresponds to fourth data. Thus, when the processor 201 executes information processing based on the payment program PRC, a computer that includes the processor 201 as the brain functions as a second generation means.

In ACT37, the processor 201 generates payment adjustment sheet data. The processor 201 generates payment adjustment sheet data as data of an image represented by disposing character strings representing item names and numerical values such that humans can easily grasp which item each of the values obtained as a result of the adjustment in ACT35 relates to. In the case where the processor 201 finishes generating the payment adjustment sheet data, the processor 201 ends the adjustment processing. Note that the processor 201 stores the transaction adjustment data, the transaction adjustment sheet data, the payment adjustment data, and the payment adjustment sheet data generated in ACT33, ACT34, ACT36, and ACT37 in the main memory 202 or the auxiliary storage device 203.

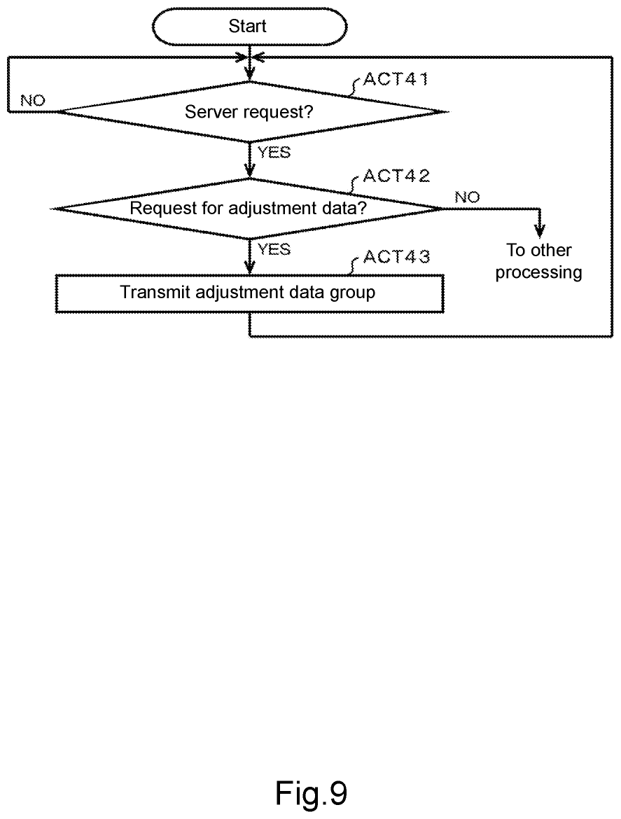

Meanwhile, in the payment apparatus 200, the processor 201 executes, as processing of a thread different from those of the payment processing and the adjustment processing, upload processing in accordance with the payment program 2031. FIG. 9 is a flowchart showing upload processing performed by the processor 201.

In ACT41, the processor 201 determines whether or not a request from the management server 300 has been received. In the case where it is determined that a request from the management server 300 has not been received (NO in ACT41), the processing of the processor 201 returns to the stand-by state standing by for receiving a request from the management server 300. In the management server 300, when predetermined collection timing has been reached, the processor 301 starts collection processing in accordance with the management program 3031. Assumption is made that the collection timing is, for example, a start time set outside the business hours of a shopping center. The collection timing may be appropriately determined by, for example, the operator of the shopping center.

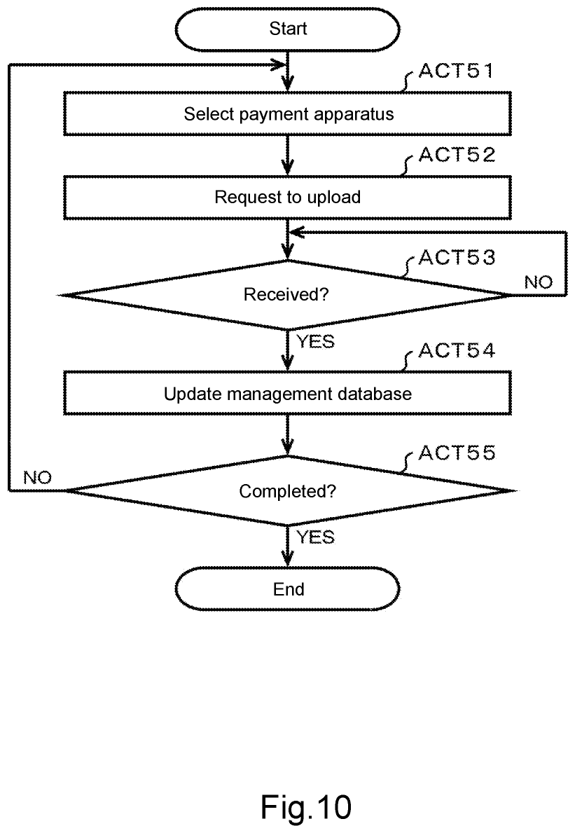

FIG. 10 is a flowchart showing collection processing performed by the processor 301. In ACT51, the processor 301 selects one of the plurality of payment apparatuses 200. In ACT52, the processor 301 requests the payment apparatus 200 selected in ACT51 to upload adjustment data. The processor 301 transmits, for example, a predetermined request command for requesting the upload of adjustment data from the communication device 304 to the communication network 2 with the payment apparatus 200 selected in ACT51 as a destination. When this request command is transmitted to the payment apparatus 200 as a destination by the communication network 2, the transmitted request command is received by the communication device 209 of the payment apparatus 200. In response to this, the processor 201 of the payment apparatus 200 including the communication device 209 that has received the request command determines that a request from the management server 300 has been received (YES in ACT41 in FIG. 9). The processing of the processor 201 proceeds to ACT42. However, a request different from the request of the upload of adjustment data is made from the management server 300 to the payment apparatus 200 in some cases. Also in this case, it is determined that a request from the management server 300 has been received (YES in ACT41), the processing of the processor 201 proceeds to ACT42.

In ACT42, the processor 201 checks whether or not the request command included in a request from the management server 300 is a request of the upload of adjustment data. In the case where it is confirmed that the request command is another request (NO in ACT42), the processing of the processor 201 proceeds to processing according to the request. Description of the processing of the processor 201 in this case is omitted. However, in the case where it is confirmed that the request command is a request of the upload of adjustment data (YES in ACT42), the processing of the processor 201 proceeds to ACT43.

In ACT43, the processor 201 transmits an adjustment data group including transaction adjustment data, transaction adjustment sheet data, payment adjustment data, and payment adjustment sheet data to the management server 300. The processor 201 generates, for example, upload data including transaction adjustment data, transaction adjustment sheet data, payment adjustment data, and payment adjustment sheet data that are generated by adjustment processing as described above and are stored in the main memory 202 or the auxiliary storage device 203. The processor 201 transmits the upload data from the communication device 209 to the communication network 2 with the management server 300 as a destination. Note that the processor 201 may cause the upload data to include date-and-time information relating to the execution timing of adjustment processing. As a result, the transaction adjustment data as the second data, the transaction adjustment sheet data as the third data relating to an image representing the transaction adjustment data, and the payment adjustment data as the fourth data are transmitted to the management server 300 as a management apparatus. Thus, when the processor 201 executes information processing based on the payment program 2031, a computer that includes the processor 201 as the brain realizes a second transmission means and a third transmission means in cooperation with the communication device 209. After that, the processor 201 returns to the stand-by state in ACT41. When the upload data is transmitted to the management server 300 by the communication network 2, the upload data is received by the communication device 304. The communication device 304 is an example of a second reception means and a third reception means.

In the management server 300, after the upload is requested in ACT52, the processing of the processor 301 proceeds to ACT53. In ACT53, the processor 301 determines whether or not the upload data has been received from the payment apparatus 200. In the case where it is determined that the upload data has not been received (NO in ACT53), the processor 301 returns to the stand-by state standing by for receiving the upload data. In the case where it is determined that the upload data has been received by the communication device 304 as described above (YES in ACT53), the processing of the processor 301 proceeds to ACT54.

In ACT54, the processor 301 updates the management database 3032 on the basis of the received upload data. The processor 301 generates, for example, a new adjustment data group in which the transaction adjustment data, the transaction adjustment sheet data, the payment adjustment data, and the payment adjustment sheet data included in the received upload data are respectively set in the fields 3232 to 3235 (see FIG. 5) of the data record 3200 included in the management database 3032. The processor 301 searches, for example, the management database 3032 for the data record 3200 in which the payment apparatus code of the selected payment apparatus 200 is set in the field 3210 (see FIG. 5). For example, the processor 301 adds a new field to the end of the field existing in the corresponding data record 3200 and sets the generated adjustment data group in the field. Note that the processor 301 sets the date and time relating to the acquisition of the adjustment data group in the field 3231 of the newly generated adjustment data group. For example, the processor 301 sets, in the field 3231, date-and-time information representing the date and time when the adjustment data group was generated. Alternatively, in the case where the upload data includes date-and-time information, for example, the processor 301 may set the date-and-time information in the field 3231. As a result, the processor 301 uses the management database 3032 to manage the transaction adjustment data as the second data, the transaction adjustment sheet data as the third data relating to an image represented by the transaction adjustment data, and the payment adjustment data as the fourth data. Thus, when the processor 301 executes information processing based on the management program 3031, a computer that includes the processor 301 as the brain functions as a first management means and a second management means.

In ACT55, the processor 301 determines whether or not collection of adjustment data from all the payment apparatuses 200 from which adjustment data is to be collected by this collection processing has been completed. Assumption is made that the payment apparatus 200 from which adjustment data is to be collected by this collection processing is all the payment apparatuses 200 included in the transaction processing system 1. However, all the payment apparatuses 200 included in the transaction processing system 1 may be divided into a plurality of groups and the processor 301 may execute collection processing on the payment apparatus 200 belonging to the respective groups at different timings. The processor 301 determines, in the case where all the target payment apparatuses 200 have not been selected, for example, that collection of adjustment data from all the target payment apparatuses 200 has not been completed (NO in ACT55). Then, the processor 301 repeats the processing of ACT51 and subsequent ACTs in the same manner as described above. However, in ACT51, the processor 301 selects the payment apparatus 200 that has not been selected during the current collection processing, of the payment apparatuses 200 that are targets of the current collection processing. As a result, the processor 301 adds an adjustment data group based on the upload data transmitted from each of the target payment apparatuses 200 to the management database 3032. The processor 301 then determines, in the case where all the payment apparatuses 200 that are targets of the current collection processing have been selected, that collection of adjustment data from all the target payment apparatuses 200 has been completed (YES in ACT55). Then, the processor 301 ends the collection processing.

As described above, in the transaction processing system 1, the payment apparatus 200 acquires, from the transaction processing apparatus 100, print data of an adjustment sheet representing a result of adjustment of the performance of transaction processing. The payment apparatus 200 generates, on the basis of the print data, transaction adjustment data representing the result of adjustment of the performance of transaction processing such that the result can be easily interpreted by a computer. The management server 300 acquires the transaction adjustment data from the payment apparatus 200 and manages the acquired transaction adjustment data. Therefore, even if a tenant does not submit an adjustment sheet using receipt paper or the like to an operator, the operator can manage, by a computer, the performance of a transaction in each tenant on the basis of the transaction adjustment data managed by the management server 300. That is, it is possible to make the management of the transaction performance of the tenant by the operator more easily.

Further, in the transaction processing system 1, the payment apparatus 200 generates transaction adjustment sheet data that is data relating to an image representing a result of adjustment of the performance of transaction processing such that humans can easily grasp the result. The management server 300 manages the generated transaction adjustment sheet data. Therefore, by referring to the image represented by the transaction adjustment sheet data, a person in charge of management or the like can easily check the performance of a transaction.

Further, in the transaction processing system 1, the transaction processing apparatus 100 transmits print data for printing an adjustment sheet to the payment apparatus 200. For this reason, the transaction processing apparatus 100 does not need to generate data suitable for management in the management server 300. The processor 101 of the transaction processing apparatus 100 executes information processing for transmitting print data to the payment apparatus 200 as scraping processing based on the scraper program 1032 separately from transaction processing. For this reason, by installing the scraper program 1032 in an existing POS terminal, an existing cash register, or the like, the transaction processing apparatus 100 can be realized.

Further, in the transaction processing system 1, the payment apparatus 200 generates payment adjustment data representing a result of the performance of payment in the payment apparatus 200 such that the result can be easily interpreted by a computer. The management server 300 acquires the payment adjustment data from the payment apparatus 200 and manages the acquired payment adjustment data. Therefore, it is also possible to make the management of the performance of payment relating to a transaction processed by the transaction processing apparatus 100 by the operator more easily.

Further, in the transaction processing system 1, the payment apparatus 200 generates payment adjustment sheet data that is data relating to an image representing a result of adjustment of the performance of payment such that humans can easily grasp the result. The management server 300 manages the generated transaction adjustment sheet data. Therefore, by referring to the image represented by the payment adjustment sheet data, a person in charge of management or the like can easily check the performance of payment.

The above-mentioned embodiment can be modified in various ways as follows. For example, generation and collection of part or all of transaction adjustment sheet data, payment adjustment data, and payment adjustment sheet data do not necessarily need to be performed.

Part or all of the journal data 1033 may be transmitted from the transaction processing apparatus 100 to the payment apparatus 200 instead of print data. In the transaction processing apparatus 100, the processor 201 may generate, on the basis of the journal data, transaction adjustment data representing a result of adjustment of a transaction and transaction adjustment sheet data.

The data transmission from the transaction processing apparatus 100 to the payment apparatus 200 may be executed as processing in transaction processing by the processor 101.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transaction processing system, comprising:
a plurality of transaction processing apparatuses, each of which executes information processing for processing a transaction;
a plurality of payment apparatuses, each of which is connected to the corresponding transaction processing apparatus and executes information processing for payment relating to the transaction processed by the information processing executed by the transaction processing apparatus; and
a management apparatus that manages the transaction processed by the information processing executed by the transaction processing apparatus,
each of the transaction processing apparatuses including
a first communication device that performs data communication with the corresponding payment apparatus, and
a first processor configured to
generate first data indicating a result of adjustment for a plurality of processed transactions, and
transmit the generated first data to the payment apparatus via the first communication device,
each of the payment apparatuses including
a second communication device that performs data communication with the corresponding transaction processing apparatus and the management apparatus, and
a second processor configured to
receive, via the second communication device, the first data transmitted via the first communication device,
convert the first data received via the second communication device into second data, and
transmit the second data obtained by the conversion to the management apparatus via the second communication device,
the management apparatus including
a third communication device that performs data communication with the payment apparatus, and
a third processor configured to
receive, via the third communication device, the second data transmitted via the second communication device, and
manage the second data received via the third communication device.

2. The transaction processing system according to claim 1, wherein
the first data is print data relating to an image representing a result of adjustment for a plurality of processed transactions,
the second data is data obtained by extracting a character string representing an item name and a numerical value relating to a predetermined item to be extracted from character strings included in the first data,
the payment apparatus further includes a storage device that stores a setting file, the setting file including, for each of the payment apparatuses, setting data representing an item to be extracted in consideration of a form of the first data generated in the transaction processing apparatus connected to the corresponding payment apparatus, and
the second processor
determines, on a basis of the setting data included in the setting file, the item to be extracted, and
extracts, from the first data, a character string representing an item name and a numerical value relating to the determined item to be extracted to generate the second data.

3. The transaction processing system according to claim 1, wherein
the management apparatus further includes a management database that includes a plurality of data records associated with the plurality of payment apparatuses, the second data being used as transaction adjustment data relating to the payment apparatus and being set in the corresponding data record, and
the third processor manages the second data using the management database.

4. The transaction processing system according to claim 1, wherein
the first processor transmits, as the first data, print data for printing an image representing a result of adjustment for a plurality of processed transactions to the payment apparatus via the first communication device.

5. The transaction processing system according to claim 4, wherein
the second processor extracts information representing an adjustment result from an image represented by the first data received by the second communication device and generates the second data as data including the extracted information.

6. The transaction processing system according to claim 5, wherein
the second processor
generates third data relating to an image representing the generated second data, and
transmits, together with the second data, the third data generated from the second data to the management apparatus via the second communication device.

7. The transaction processing system according to claim 6, wherein
the third processor
receives, via the third communication device, the third data together with the second data, and
manages the received second data and the third data received together with the second data in association with each other.

8. The transaction processing system according to claim 1, wherein
the second processor
generates fourth data representing a result of adjustment for a plurality of payments on which information processing has been executed, and
transmits the generated fourth data to the management apparatus via the second communication device.

9. The transaction processing system according to claim 8, wherein
the third processor
receives, via the third communication device, the fourth data transmitted via the second communication device, and
manages the received fourth data.

10. A transaction processing system, comprising:
a processing apparatus that executes information processing for processing a transaction;
a management apparatus that manages a transaction processed by the information processing executed by the transaction processing apparatus; and
a payment apparatus that executes information processing for payment relating to the transaction processed by the information processing executed by the transaction processing apparatus and includes
a communication device that performs data communication with the transaction processing apparatus and the management apparatus, and
a processor configured to
receive, via the communication device, first data transmitted from the transaction processing apparatus, the first data representing a result of adjustment for a plurality of processed transactions,
convert the first data received via the communication device into second data, and
transmit the second data obtained by the conversion to the management apparatus via the communication device.
